(19) United States
(12) Patent Application Publication
(10) Pub. No.: US 2026/0213449 A1
(43) Pub. Date: Jul. 23, 2026

(54) COMBINED TERMINAL, CONNECTOR AND CONNECTOR ASSEMBLY

(71) Applicants: Tyco Electronics (Shanghai) Co., Ltd., Shanghai (CN); Tyco Electronics Technology (SIP) Co., Ltd., Suzhou (CN)

(72) Inventors: Kai Wang, Suzhou (CN); Weidong Zhang, Shanghai (CN); Lei Pan, Shanghai (CN)

(73) Assignees: Tyco Electronics (Shanghai) Co., Ltd., Shanghai (CN); Tyco Electronics Technology (SIP) Co., Ltd., Suzhou (CN)

(21) Appl. No.: 19/453,175

(22) Filed: Jan. 20, 2026

(30) Foreign Application Priority Data
Jan. 20, 2025 (CN) 202510088738.6

(51) Int. Cl. H01R 13/20; H01R 4/18; H01R 4/62; H01R 11/11; H01R 13/03; H01R 13/11; H01R 13/24

(52) U.S. Cl. CPC H01R 13/20; H01R 4/184; H01R 4/62; H01R 11/11; H01R 13/03; H01R 13/113; H01R 13/245; H01R 13/2457

(57) ABSTRACT

A combined terminal includes a terminal having a first elastic arm formed at the front of the terminal, and a shell sleeved on the front of the terminal. A contact protrusion or a second elastic arm protruding toward the first elastic arm is formed on a top wall of the shell, and the contact protrusion or the second elastic arm is oppositely spaced from the first elastic arm to clamp a mating terminal inserted between the contact protrusion or the second elastic arm and the first elastic arm. A conductive property of a manufacturing material for the terminal is distinct to a conductive property of a manufacturing material for the shell, and a mechanical property of the manufacturing material for the shell is distinct to a mechanical property of the manufacturing material for the terminal.

### CROSS-REFERENCE TO RELATED APPLICATION

This application claims the benefit of Chinese Patent Application No. CN 202510088738.6 filed on Jan. 20, 2025 in the State Intellectual Property Office of China, the whole disclosure of which is incorporated herein by reference.

### FIELD OF THE INVENTION

The disclosure relates to a combined terminal, a connector including the combined terminal, and a connector assembly including the connector.

### BACKGROUND OF THE INVENTION

In the prior art, connector terminals are typically copper terminals. However, the copper terminals have high costs and marginal mechanical properties, so it is difficult to ensure reliable electrical contact with mating terminals.

### SUMMARY OF THE INVENTION

According to an embodiment of the present disclosure, a combined terminal includes a terminal having a first elastic arm formed at the front of the terminal, and a shell sleeved on the front of the terminal. A contact protrusion or a second elastic arm protruding toward the first elastic arm is formed on a top wall of the shell, and the contact protrusion or the second elastic arm is oppositely spaced from the first elastic arm to clamp a mating terminal inserted between the contact protrusion or the second elastic arm and the first elastic arm. A conductive property of a manufacturing material for the terminal is distinct to a conductive property of a manufacturing material for the shell, and a mechanical property of the manufacturing material for the shell is distinct to a mechanical property of the manufacturing material for the terminal.

### BRIEF DESCRIPTION OF DRAWINGS

The above and other features of the present invention will become more apparent by describing in detail exemplary embodiments thereof with reference to the accompanying drawings, in which:

FIG. 1 shows an illustrative perspective view of a combined terminal according to a first exemplary embodiment of the present disclosure;

FIG. 2 shows an illustrative exploded view of the combined terminal according to the first exemplary embodiment of the present disclosure;

FIG. 3 shows an illustrative perspective view of a terminal of a combined terminal according to the first exemplary embodiment of the present disclosure;

FIG. 4 shows an exploded sectional view of the combined terminal according to the first exemplary embodiment of the present disclosure;

FIG. 5 shows a perspective sectional view of the combined terminal according to the first exemplary embodiment of the present disclosure;

FIG. 6 shows a planar sectional view of the combined terminal according to the first exemplary embodiment of the present disclosure;

FIG. 7 shows an illustrative perspective view of a combined terminal according to a second exemplary embodiment of the present disclosure;

FIG. 8 shows an illustrative exploded view of the combined terminal according to the second exemplary embodiment of the present disclosure;

FIG. 9 shows an illustrative perspective view of a terminal of the combined terminal according to the second exemplary embodiment of the present disclosure;

FIG. 10 shows an exploded sectional view of the combined terminal according to the second exemplary embodiment of the present disclosure;

FIG. 11 shows a perspective sectional view of the combined terminal according to the second exemplary embodiment of the present disclosure;

FIG. 12 shows a planar sectional view of the combined terminal according to the second exemplary embodiment of the present disclosure;

FIG. 13 shows an illustrative perspective view of a combined terminal according to a third exemplary embodiment of the present disclosure;

FIG. 14 shows an illustrative exploded view of the combined terminal according to the third exemplary embodiment of the present disclosure;

FIG. 15 shows an illustrative perspective view of a terminal of the combined terminal according to the third exemplary embodiment of the present disclosure;

FIG. 16 shows an exploded sectional view of the combined terminal according to the third exemplary embodiment of the present disclosure;

FIG. 17 shows a perspective sectional view of the combined terminal according to the third exemplary embodiment of the present disclosure;

FIG. 18 shows a planar sectional view of the combined terminal according to the third exemplary embodiment of the present disclosure;

FIG. 19 shows an illustrative perspective view of a combined terminal according to a fourth exemplary embodiment of the present disclosure;

FIG. 20 shows an illustrative exploded view of the combined terminal according to the fourth exemplary embodiment of the present disclosure;

FIG. 21 shows an illustrative perspective view of a terminal of the combined terminal according to the fourth exemplary embodiment of the present disclosure;

FIG. 22 shows an exploded sectional view of the combined terminal according to the fourth exemplary embodiment of the present disclosure;

FIG. 23 shows an illustrative sectional view of the combined terminal according to the fourth exemplary embodiment of the present disclosure; and

FIG. 24 shows a planar sectional view of the combined terminal according to the fourth exemplary embodiment of the present disclosure.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to a general concept of the present invention, there is provided a combined terminal. The combined terminal includes: a terminal having a first elastic arm formed at the front of the terminal; and a shell sleeved on the front of the terminal. A contact protrusion or a second elastic arm protruding toward the first elastic arm is formed on a top wall of the shell, and the contact protrusion or the second elastic arm is oppositely spaced from the first elastic arm to clamp a mating terminal inserted between the contact protrusion or the second elastic arm and the first elastic arm. A conductive property of a manufacturing material for the terminal is superior to a conductive property of a manufacturing material for the shell, and a mechanical property of the manufacturing material for the shell is superior to a mechanical property of the manufacturing material for the terminal.

According to another general concept of the present invention, there is provided a connector. The connector includes: a connector shell; and the above combined terminal, the combined terminal is inserted into the connector shell.

According to another general concept of the present invention, there is provided a connector assembly. The connector assembly includes: the above connector; and a mating connector mating with the connector. The mating connector includes: a mating shell; and a mating terminal disposed in the mating shell. The mating terminal is inserted between a first elastic arm and a second elastic arm of the combined terminal or between the first elastic arm and a contact protrusion.

### First Exemplary Embodiment

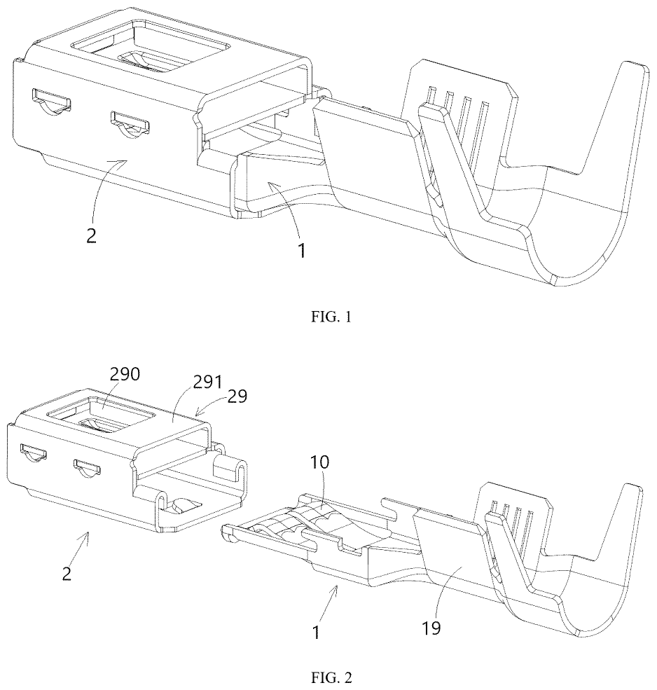

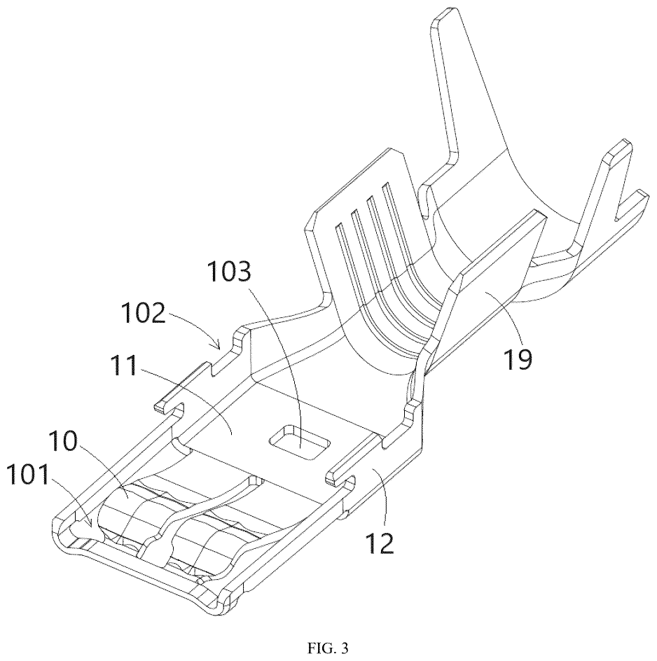

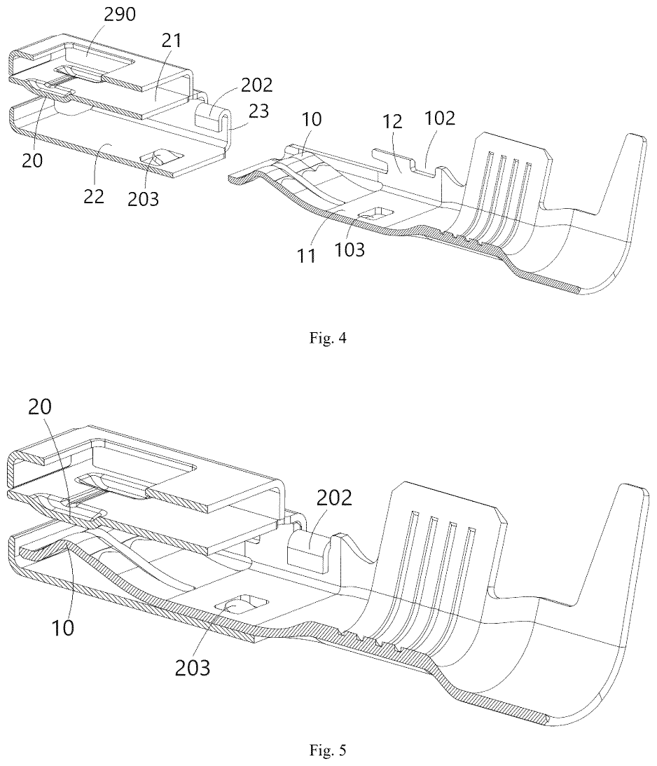

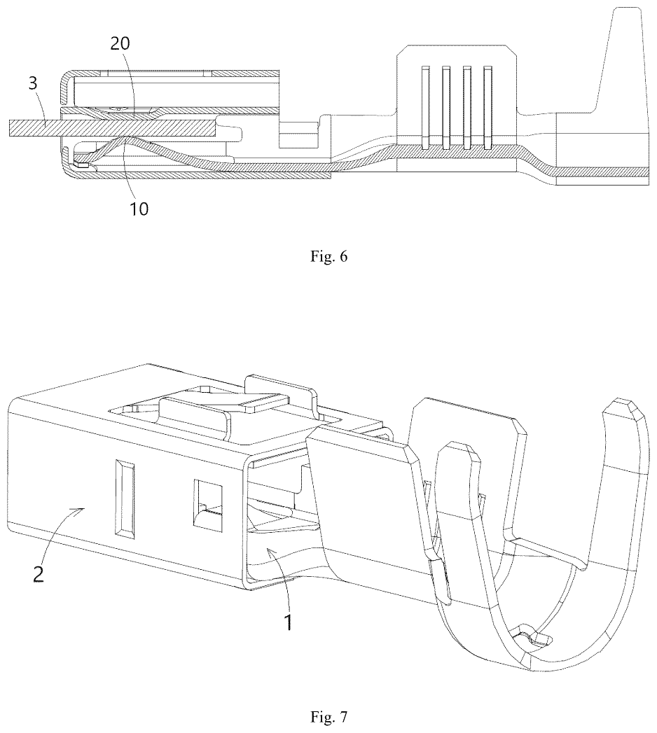

FIG. 1 to FIG. 6 show the first exemplary embodiment of the present disclosure. Among them, FIG. 1 shows an illustrative perspective view of a combined terminal according to a first exemplary embodiment of the present disclosure; FIG. 2 shows an illustrative exploded view of the combined terminal according to the first exemplary embodiment of the present disclosure; FIG. 3 shows an illustrative perspective view of a terminal of a combined terminal according to the first exemplary embodiment of the present disclosure; FIG. 4 shows an exploded sectional view of the combined terminal according to the first exemplary embodiment of the present disclosure; FIG. 5 shows a perspective sectional view of the combined terminal according to the first exemplary embodiment of the present disclosure; FIG. 6 shows a planar sectional view of the combined terminal according to the first exemplary embodiment of the present disclosure.

As shown in FIGS. 1 to 6, in an exemplary embodiment of the present invention, a combined terminal is disclosed. The combined terminal includes: a terminal 1 and a shell 2. A first elastic arm 10 formed at the front of the terminal 1. The shell 2 is sleeved on the front of the terminal 1. A contact protrusion 20 protruding toward the first elastic arm 10 is formed on a top wall 21 of the shell 2, and the contact protrusion 20 is oppositely spaced from the first elastic arm 10 to clamp a mating terminal 3 inserted between the contact protrusion or the second elastic arm and the first elastic arm. In the illustrated embodiment, a conductive property of a manufacturing material for the terminal 1 is superior to a conductive property of a manufacturing material for the shell 2, and a mechanical property of the manufacturing material for the shell 2 is superior to a mechanical property of the manufacturing material for the terminal 1.

As shown in FIGS. 1 to 6, in an exemplary embodiment of the present invention, the terminal 1 can be a copper terminal or a copper alloy terminal, and the shell 2 can be a stainless steel shell.

As shown in FIGS. 1 to 6, in the illustrated embodiment, the terminal 1 is an integral stamped part. The shell 2 is an integral stamped part.

As shown in FIGS. 1 to 6, in the illustrated embodiment, the front of the terminal 1 comprises a bottom plate 11, and a bottom wall 22 of the shell 2 abuts against a bottom surface of the bottom plate 11 of the terminal 1. A window 101 is formed in the bottom plate 11 of the terminal 1, and the first elastic arm 10 of the terminal 1 is suspended in the window 101.

As shown in FIGS. 1 to 6, in the illustrated embodiment, a front end and a rear end of the first elastic arm 10 are respectively connected to a front side and a rear side of the window 101 in the bottom plate 11, and the first elastic arm 10 protrudes toward a top wall 21 of the shell 2 for electrical contact with the inserted mating terminal 3.

As shown in FIGS. 1 to 6, in the illustrated embodiment, the terminal 1 includes a plurality of first elastic arms 10 arranged side by side in a width direction of the terminal, and the shell 2 includes a plurality of contact protrusions 20 corresponding to the plurality of first elastic arms 10 respectively.

As shown in FIGS. 1 to 6, in the illustrated embodiment, the rear of the terminal 1 is located outside the shell 2, and a crimping portion 19 crimped onto a cable (not shown) is formed on the rear of the terminal 1 for electrical connection with the cable.

As shown in FIGS. 1 to 6, in the illustrated embodiment, the shell 2 has two side walls 23 opposite in a width direction of the shell, and riveting tabs 202 are formed on the side walls 23 of the shell 2. The front of the terminal 1 has two side plates 12 opposite in a width direction of the terminal, and grooves 202 are formed on upper sides of the side plates 12 of the terminal 1. The riveting tabs 202 on the side walls 23 of the shell 2 are riveted into the grooves 202 in the side plates 12 of the terminal 1 to secure the front of the terminal 1 into the shell 2.

As shown in FIGS. 1 to 6, in the illustrated embodiment, a tab 203 is formed on one of a bottom plate 11 at the front of the terminal 1 and a bottom wall 22 of the shell 2, a snap slot 103 is formed in the other, and the tab 203 is locked into the snap slot 103 to lock the front of the terminal 1 into the shell 2.

As shown in FIGS. 1 to 6, in the illustrated embodiment, the shell 2 further includes a locking structure located on an outer side of the top wall 21 and/or the bottom wall 22 of the shell, and the locking structure is adapted to engage with a connector shell (not shown) to lock the combined terminal into the connector shell.

As shown in FIGS. 1 to 6, in the illustrated embodiment, the above locking structure includes a top cover 29 located above the top wall 21 of the shell 2, an opening 290 is formed in a top plate 291 of the top cover 29, and the opening 290 is adapted to engage with an elastic snap-fit fastener (not shown) in the connector shell (not shown) to lock the combined terminal into the connector shell.

As shown in FIGS. 1 to 6, in another exemplary embodiment of the present invention, a connector is further disclosed. The connector includes: a connector shell and the above combined terminal. The combined terminal is inserted into the connector shell.

As shown in FIGS. 1 to 6, in another exemplary embodiment of the present invention, a connector assembly is further disclosed. The connector assembly includes: the above connector and a mating connector. The mating connector mates with the connector. The mating connector includes: a mating shell (not shown) and a mating terminal 3. The mating terminal 3 is disposed in the mating shell. The mating terminal 3 is inserted between the first elastic arm 10 and a contact protrusion 20.

### Second Exemplary Embodiment

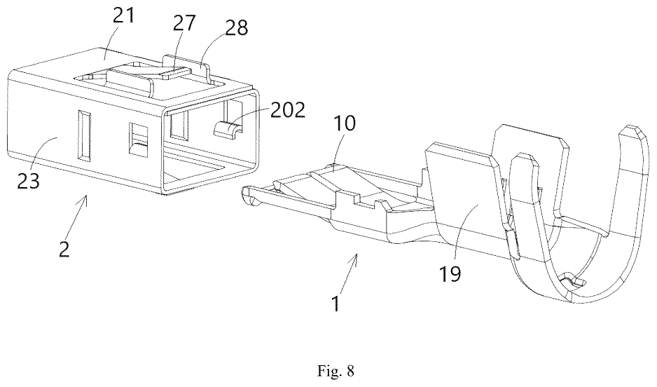

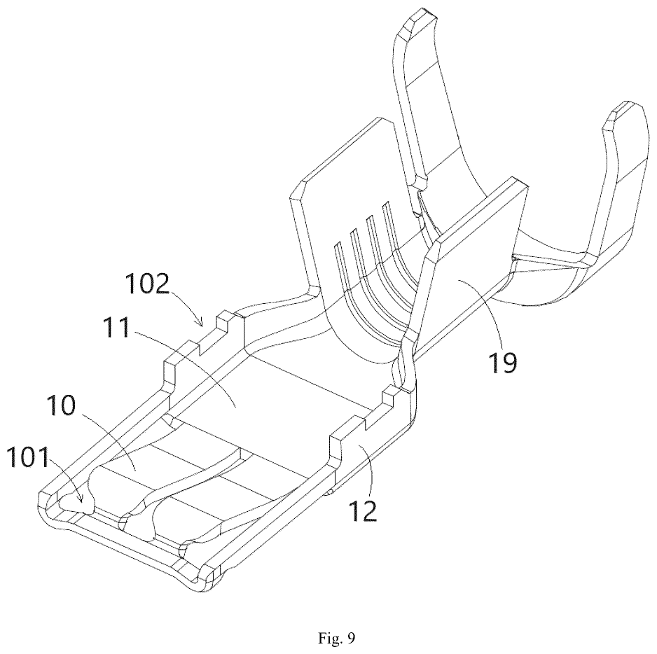

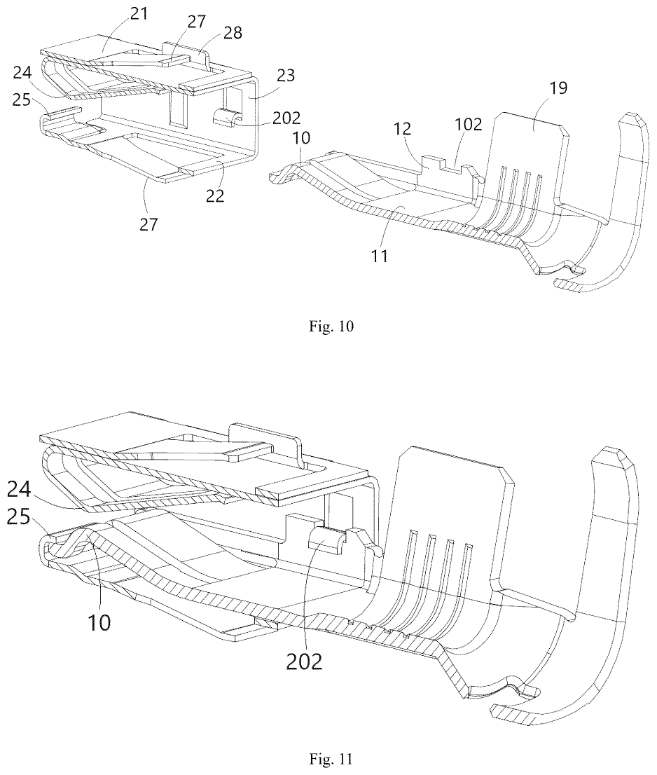

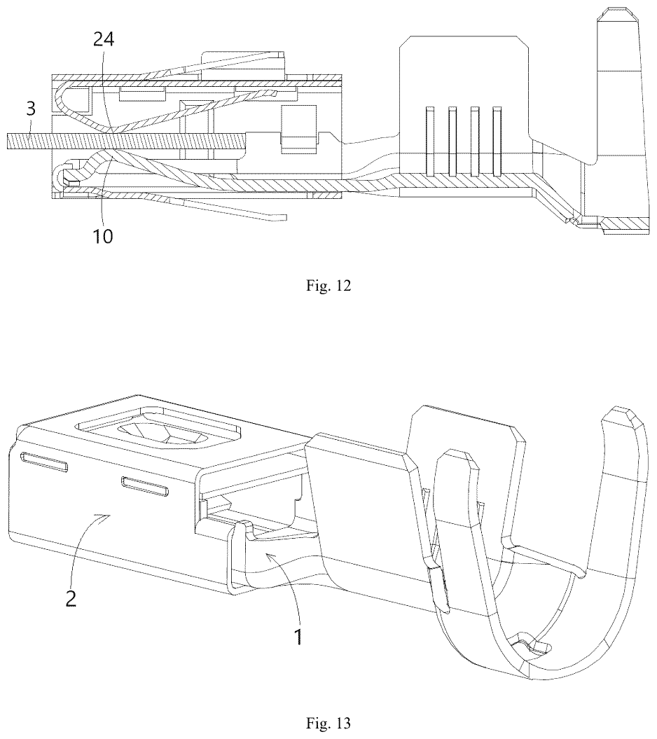

FIG. 7 to FIG. 12 show the second exemplary embodiment of the present disclosure. Among them, FIG. 7 shows an illustrative perspective view of a combined terminal according to a second exemplary embodiment of the present disclosure; FIG. 8 shows an illustrative exploded view of the combined terminal according to the second exemplary embodiment of the present disclosure; FIG. 9 shows an illustrative perspective view of a terminal of the combined terminal according to the second exemplary embodiment of the present disclosure; FIG. 10 shows an exploded sectional view of the combined terminal according to the second exemplary embodiment of the present disclosure; FIG. 11 shows a perspective sectional view of the combined terminal according to the second exemplary embodiment of the present disclosure; FIG. 12 shows a planar sectional view of the combined terminal according to the second exemplary embodiment of the present disclosure.

As shown in FIGS. 7 to 12, in an exemplary embodiment of the present invention, a combined terminal is disclosed. The combined terminal includes: a terminal 1 and a shell 2. A first elastic arm 10 is formed at the front of the terminal. The shell 2 is sleeved on the front of the terminal 1. A second elastic arm 24 protruding toward the first elastic arm 10 is formed on a top wall 21 of the shell 2. The second elastic arm 24 is oppositely spaced from the first elastic arm 10 to clamp a mating terminal 3 inserted between the contact protrusion or the second elastic arm and the first elastic arm. In the illustrated embodiment, a conductive property of a manufacturing material for the terminal 1 is superior to a conductive property of a manufacturing material for the shell 2, and a mechanical property of the manufacturing material for the shell 2 is superior to a mechanical property of the manufacturing material for the terminal 1.

As shown in FIGS. 7 to 12, in an exemplary embodiment of the present invention, the terminal 1 can be a copper terminal or a copper alloy terminal, and the shell 2 can be a stainless steel shell.

As shown in FIGS. 7 to 12, in the illustrated embodiment, the terminal 1 is an integral stamped part. The shell 2 is an integral stamped part.

As shown in FIGS. 7 to 12, in the illustrated embodiment, the front of the terminal 1 comprises a bottom plate 11, and a bottom wall 22 of the shell 2 abuts against a bottom surface of the bottom plate 11 of the terminal 1. A window 101 is formed in the bottom plate 11 of the terminal 1, and the first elastic arm 10 of the terminal 1 is suspended in the window 101.

As shown in FIGS. 7 to 12, in the illustrated embodiment, a front end and a rear end of the first elastic arm 10 are respectively connected to a front side and a rear side of the window 101 in the bottom plate 11, and the first elastic arm 10 protrudes toward a top wall 21 of the shell 2 for electrical contact with the inserted mating terminal 3.

As shown in FIGS. 7 to 12, in the illustrated embodiment, the terminal 1 includes a plurality of first elastic arms 10 arranged side by side in a width direction of the terminal, and the shell 2 includes a plurality of second elastic arms 24 corresponding to the plurality of first elastic arms 10 respectively.

As shown in FIGS. 7 to 12, in the illustrated embodiment, a second elastic arm 24 is formed on the top wall 21 of the shell 2, and a front end of the second elastic arm 24 is connected to a front side of the top wall 21 and bent backward relative to the front side of the top wall 21. The second elastic arm 24 is suspended below the top wall 21 and protrudes toward the first elastic arm 10 for electrical contact with the inserted mating terminal 3.

As shown in FIGS. 7 to 12, in the illustrated embodiment, a tail end of the second elastic arm 24 is adapted to be slidably supported on an inner surface of the top wall 21 when the combined terminal mates with the mating terminal 3.

As shown in FIGS. 7 to 12, in the illustrated embodiment, the shell 2 includes a plurality of second elastic arms 24 arranged side by side in a width direction of the shell, and the terminal 1 includes a plurality of first elastic arms 10 corresponding to the plurality of second elastic arms 24 respectively.

As shown in FIGS. 7 to 12, in the illustrated embodiment, the rear of the terminal 1 is located outside the shell 2, and a crimping portion 19 crimped onto a cable (not shown) is formed on the rear of the terminal 1 for electrical connection with the cable.

As shown in FIGS. 7 to 12, in the illustrated embodiment, the shell 2 has two side walls 23 opposite in a width direction of the shell, and riveting tabs 202 are formed on the side walls 23 of the shell 2. The front of the terminal 1 has two side plates 12 opposite in a width direction of the terminal, and grooves 202 are formed on upper sides of the side plates 12 of the terminal 1. The riveting tabs 202 on the side walls 23 of the shell 2 are riveted into the grooves 202 in the side plates 12 of the terminal 1 to secure the front of the terminal 1 into the shell 2.

As shown in FIGS. 7 to 12, in the illustrated embodiment, the shell 2 further includes a locking structure located on an outer side of the top wall 21 and/or the bottom wall 22 of the shell, and the locking structure is adapted to engage with a connector shell (not shown) to lock the combined terminal into the connector shell.

As shown in FIGS. 7 to 12, in the illustrated embodiment, the locking structure includes a locking tab 27 formed on the outer side of the top wall 21 and/or the bottom wall 22 of the shell 2, the locking tab 27 is adapted to engage with a locking slot (not shown) in the connector shell to lock the combined terminal into the connector shell.

As shown in FIGS. 7 to 12, in the illustrated embodiment, a guide rib 28 is formed on the top wall 21 and/or the bottom wall 22 of the shell 2, and the guide rib 28 extends in a length direction of the combined terminal. The guide rib 28 is configured to mate with a guide slot (not shown) in the connector shell to guide the insertion of the combined terminal into the connector shell.

As shown in FIGS. 7 to 12, in the illustrated embodiment, a limiting portion 25 turned inward is formed on a front side of the bottom wall 22 of the shell 2, and the limiting portion 25 is pressed downward on a front end of the first elastic arm 10 of the terminal 1, such that the first elastic arm 10 is limited in an initial position having a predetermined initial contact force to increase a contact force between the first elastic arm 10 and the mating terminal 3.

As shown in FIGS. 7 to 12, in another exemplary embodiment of the present invention, a connector is further disclosed. The connector includes: a connector shell and the above combined terminal. The combined terminal is inserted into the connector shell.

As shown in FIGS. 7 to 12, in another exemplary embodiment of the present invention, a connector assembly is further disclosed. The connector assembly includes: the above connector and a mating connector. The mating connector mates with the connector. The mating connector includes: a mating shell (not shown) and a mating terminal 3. The mating terminal 3 is disposed in the mating shell. The mating terminal 3 is inserted between a first elastic arm 10 and a second elastic arm 24 of the combined terminal.

### Third Exemplary Embodiment

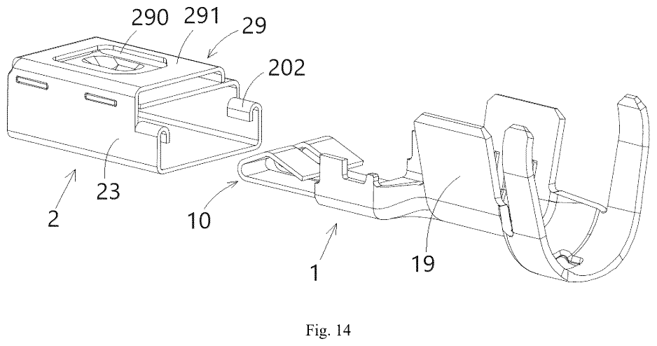

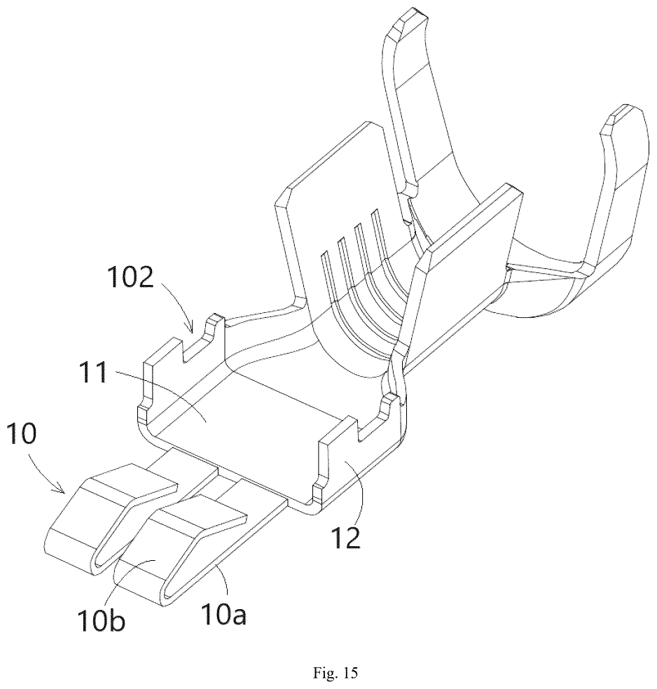

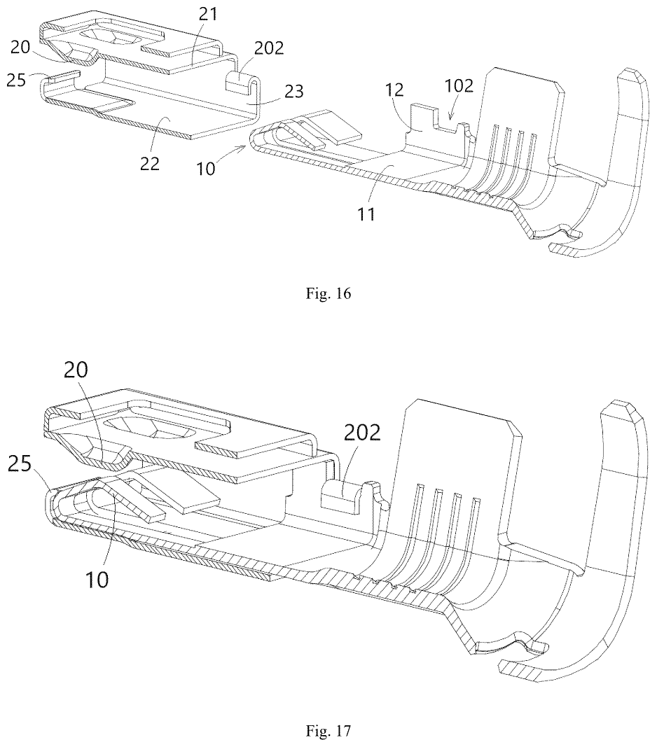

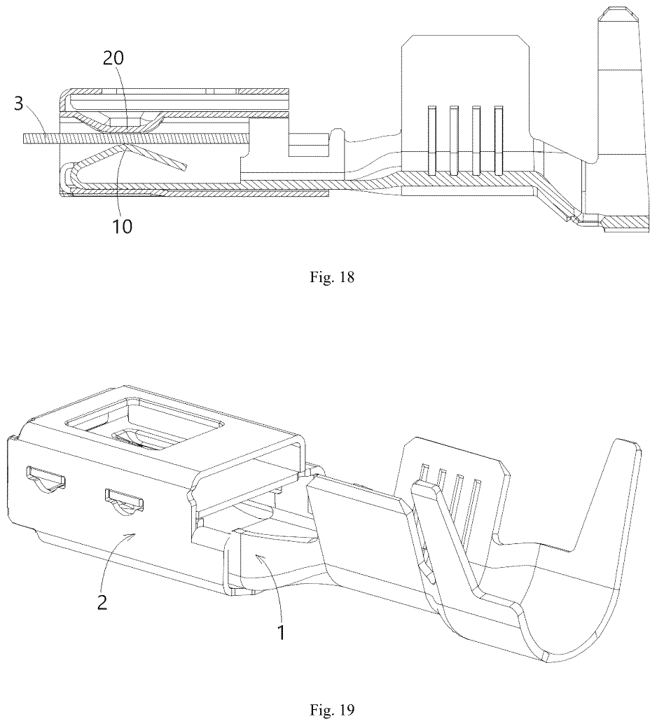

FIG. 13 to FIG. 18 show the third exemplary embodiment of the present disclosure. Among them, FIG. 13 shows an illustrative perspective view of a combined terminal according to a third exemplary embodiment of the present disclosure; FIG. 14 shows an illustrative exploded view of the combined terminal according to the third exemplary embodiment of the present disclosure; FIG. 15 shows an illustrative perspective view of a terminal of the combined terminal according to the third exemplary embodiment of the present disclosure; FIG. 16 shows an exploded sectional view of the combined terminal according to the third exemplary embodiment of the present disclosure; FIG. 17 shows a perspective sectional view of the combined terminal according to the third exemplary embodiment of the present disclosure; FIG. 18 shows a planar sectional view of the combined terminal according to the third exemplary embodiment of the present disclosure.

As shown in FIGS. 13 to 18, in an exemplary embodiment of the present invention, a combined terminal is disclosed. The combined terminal includes: a terminal 1 and a shell 2. A first elastic arm 10 is formed at the front of the terminal. The shell 2 is sleeved on the front of the terminal 1. A contact protrusion 20 protruding toward the first elastic arm 10 is formed on a top wall 21 of the shell 2. The contact protrusion 20 is oppositely spaced from the first elastic arm 10 to clamp a mating terminal 3 inserted between the contact protrusion or the second elastic arm and the first elastic arm. In the illustrated embodiment, a conductive property of a manufacturing material for the terminal 1 is superior to a conductive property of a manufacturing material for the shell 2, and a mechanical property of the manufacturing material for the shell 2 is superior to a mechanical property of the manufacturing material for the terminal 1.

As shown in FIGS. 13 to 18, in an exemplary embodiment of the present invention, the terminal 1 can be a copper terminal or a copper alloy terminal, and the shell 2 can be a stainless steel shell.

As shown in FIGS. 13 to 18, in the illustrated embodiment, the terminal 1 is an integral stamped part. The shell 2 is an integral stamped part.

As shown in FIGS. 13 to 18, in the illustrated embodiment, the front of the terminal 1 includes a bottom plate 11. A bottom wall 22 of the shell 2 abuts against a bottom surface of the bottom plate 11 of the terminal 1. The first elastic arm 10 of the terminal 1 includes: a first arm portion 10a and a second arm portion 10b. A rear end of the first arm portion 10a is connected to a front side of the bottom plate 11 and a front end of the first arm portion 10a is supported on the bottom wall 22 of the shell 2. The second arm portion 10b is connected to the front end of the first arm portion 10a and bent backward relative to the front end of the first arm portion 10a. The second arm portion 10b is suspended above the first arm portion 10a and protrudes toward the top wall 21 of the shell 2 for electrical contact with the inserted mating terminal 3.

As shown in FIGS. 13 to 18, in the illustrated embodiment, a tail end of the second arm portion 10b is adapted to be slidably supported on a top surface of the first arm portion 10a when the combined terminal mates with the mating terminal 3.

As shown in FIGS. 13 to 18, in the illustrated embodiment, the terminal 1 includes a plurality of first elastic arms 10 arranged side by side in a width direction of the terminal, and the shell 2 includes a plurality of contact protrusions 20 corresponding to the plurality of first elastic arms 10 respectively.

As shown in FIGS. 13 to 18, in the illustrated embodiment, the rear of the terminal 1 is located outside the shell 2, and a crimping portion 19 crimped onto a cable (not shown) is formed on the rear of the terminal 1 for electrical connection with the cable.

As shown in FIGS. 13 to 18, in the illustrated embodiment, the shell 2 has two side walls 23 opposite in a width direction of the shell, and riveting tabs 202 are formed on the side walls 23 of the shell 2. The front of the terminal 1 has two side plates 12 opposite in a width direction of the terminal, and grooves 202 are formed on upper sides of the side plates 12 of the terminal 1. The riveting tabs 202 on the side walls 23 of the shell 2 are riveted into the grooves 202 in the side plates 12 of the terminal 1 to secure the front of the terminal 1 into the shell 2.

As shown in FIGS. 13 to 18, in the illustrated embodiment, the shell 2 further includes a locking structure located on an outer side of the top wall 21 and/or the bottom wall 22 of the shell, and the locking structure is adapted to engage with a connector shell (not shown) to lock the combined terminal into the connector shell.

As shown in FIGS. 13 to 18, in the illustrated embodiment, the above locking structure includes a top cover 29 located above the top wall 21 of the shell 2, an opening 290 is formed in a top plate 291 of the top cover 29, and the opening 290 is adapted to engage with an elastic snap-fit fastener (not shown) in the connector shell (not shown) to lock the combined terminal into the connector shell.

As shown in FIGS. 13 to 18, in the illustrated embodiment, a limiting portion 25 turned inward is formed on a front side of the bottom wall 22 of the shell 2, and the limiting portion 25 is pressed downward on a front end of the first elastic arm 10 of the terminal 1, such that the first elastic arm 10 is limited in an initial position having a predetermined initial contact force to increase a contact force between the first elastic arm 10 and the mating terminal 3.

As shown in FIGS. 13 to 18, in another exemplary embodiment of the present invention, a connector is further disclosed. The connector includes: a connector shell and the above combined terminal. The combined terminal is inserted into the connector shell.

As shown in FIGS. 13 to 18, in another exemplary embodiment of the present invention, a connector assembly is further disclosed. The connector assembly includes: the above connector and the above mating connector. The mating connector mates with the connector. The mating connector includes: a mating shell (not shown) and a mating terminal 3. The mating terminal 3 is disposed in the mating shell. The mating terminal 3 is inserted between the first elastic arm 10 and a contact protrusion 20.

### Fourth Exemplary Embodiment

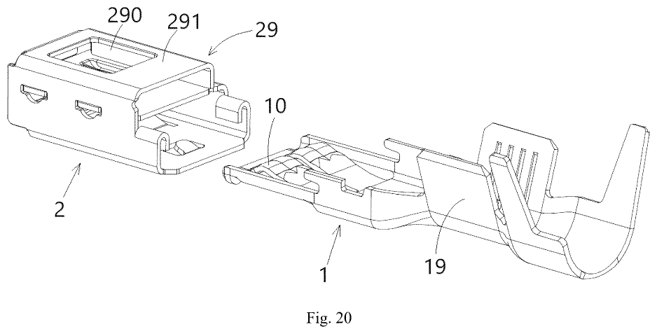

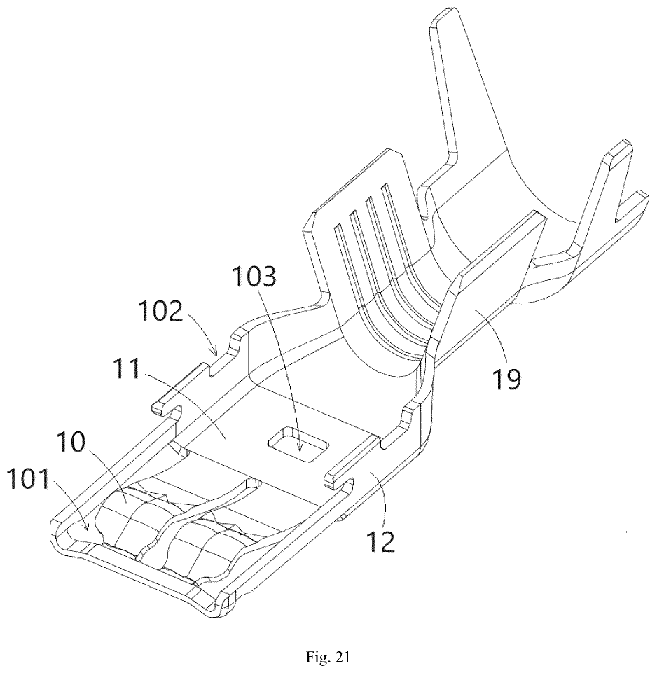

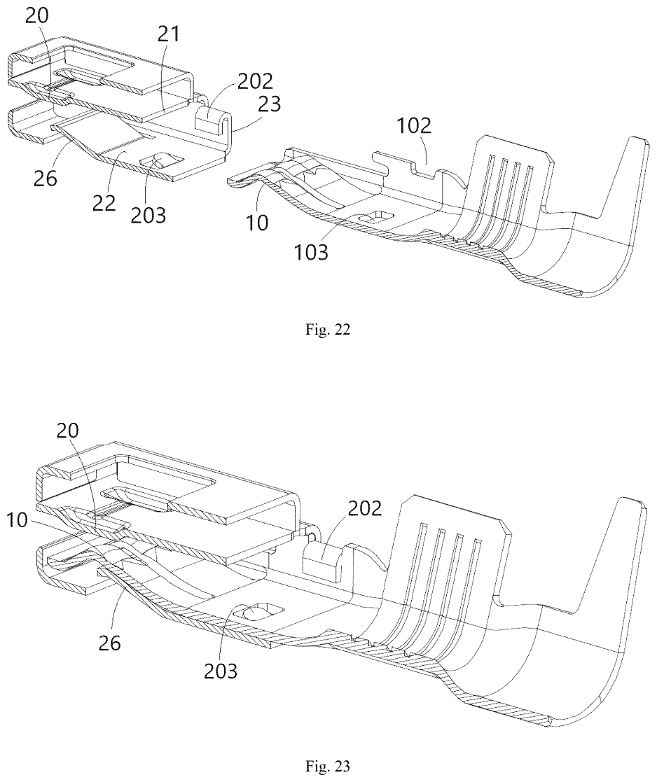

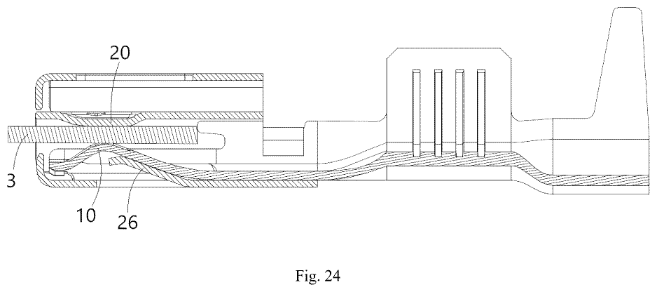

FIG. 19 to FIG. 24 show the fourth exemplary embodiment of the present disclosure. Among them, FIG. 19 shows an illustrative perspective view of a combined terminal according to a fourth exemplary embodiment of the present disclosure; FIG. 20 shows an illustrative exploded view of the combined terminal according to the fourth exemplary embodiment of the present disclosure; FIG. 21 shows an illustrative perspective view of a terminal of the combined terminal according to the fourth exemplary embodiment of the present disclosure; FIG. 22 shows an exploded sectional view of the combined terminal according to the fourth exemplary embodiment of the present disclosure; FIG. 23 shows an illustrative sectional view of the combined terminal according to the fourth exemplary embodiment of the present disclosure; and FIG. 24 shows a planar sectional view of the combined terminal according to the fourth exemplary embodiment of the present disclosure.

As shown in FIGS. 19 to 24, in an exemplary embodiment of the present invention, a combined terminal is disclosed. The combined terminal includes: a terminal 1 and a shell 2. A first elastic arm 10 is formed at the front of the terminal. The shell 2 is sleeved on the front of the terminal 1. A contact protrusion 20 protruding toward the first elastic arm 10 is formed on a top wall 21 of the shell 2. The contact protrusion 20 is oppositely spaced from the first elastic arm 10 to clamp a mating terminal 3 inserted between the contact protrusion or the second elastic arm and the first elastic arm. In the illustrated embodiment, a conductive property of a manufacturing material for the terminal 1 is superior to a conductive property of a manufacturing material for the shell 2, and a mechanical property of the manufacturing material for the shell 2 is superior to a mechanical property of the manufacturing material for the terminal 1.

As shown in FIGS. 19 to 24, in an exemplary embodiment of the present invention, the terminal 1 can be a copper terminal or a copper alloy terminal, and the shell 2 can be a stainless steel shell.

As shown in FIGS. 19 to 24, in the illustrated embodiment, the terminal 1 is an integral stamped part. The shell 2 is an integral stamped part.

As shown in FIGS. 19 to 24, in the illustrated embodiment, the front of the terminal 1 includes a bottom plate 11, and a bottom wall 22 of the shell 2 abuts against a bottom surface of the bottom plate 11 of the terminal 1. A window 101 is formed in the bottom plate 11 of the terminal 1, and the first elastic arm 10 of the terminal 1 is suspended in the window 101.

As shown in FIGS. 19 to 24, in the illustrated embodiment, a front end and a rear end of the first elastic arm 10 are respectively connected to a front side and a rear side of the window 101 in the bottom plate 11, and the first elastic arm 10 protrudes toward a top wall 21 of the shell 2 for electrical contact with the inserted mating terminal 3.

As shown in FIGS. 19 to 24, in the illustrated embodiment, the terminal 1 includes a plurality of first elastic arms 10 arranged side by side in a width direction of the terminal, and the shell 2 includes a plurality of contact protrusions 20 corresponding to the plurality of first elastic arms 10 respectively.

As shown in FIGS. 19 to 24, in the illustrated embodiment, the rear of the terminal 1 is located outside the shell 2, and a crimping portion 19 crimped onto a cable (not shown) is formed on the rear of the terminal 1 for electrical connection with the cable.

As shown in FIGS. 19 to 24, in the illustrated embodiment, the shell 2 has two side walls 23 opposite in a width direction of the shell, and riveting tabs 202 are formed on the side walls 23 of the shell 2. The front of the terminal 1 has two side plates 12 opposite in a width direction of the terminal, and grooves 202 are formed on upper sides of the side plates 12 of the terminal 1. The riveting tabs 202 on the side walls 23 of the shell 2 are riveted into the grooves 202 in the side plates 12 of the terminal 1 to secure the front of the terminal 1 into the shell 2.

As shown in FIGS. 19 to 24, in the illustrated embodiment, a tab 203 is formed on one of a bottom plate 11 at the front of the terminal 1 and a bottom wall 22 of the shell 2, a snap slot 103 is formed in the other, and the tab 203 is locked into the snap slot 103 to lock the front of the terminal 1 into the shell 2.

As shown in FIGS. 19 to 24, in the illustrated embodiment, the shell 2 further includes a locking structure located on an outer side of the top wall 21 and/or the bottom wall 22 of the shell, and the locking structure is adapted to engage with a connector shell to lock the combined terminal into the connector shell.

As shown in FIGS. 19 to 24, in the illustrated embodiment, the above locking structure includes a top cover 29 located above the top wall 21 of the shell 2, an opening 290 is formed in a top plate 291 of the top cover 29, and the opening 290 is adapted to engage with an elastic snap-fit fastener (not shown) in the connector shell (not shown) to lock the combined terminal into the connector shell.

As shown in FIGS. 19 to 24, in the illustrated embodiment, an auxiliary elastic arm 26 is formed on the bottom wall 22 of the shell 2, and the auxiliary elastic arm 26 protrudes toward the first elastic arm 10 and abuts against a bottom surface of the first elastic arm 10 to increase a contact force between the first elastic arm 10 and the mating terminal 3.

As shown in FIGS. 19 to 24, in another exemplary embodiment of the present invention, a connector is further disclosed. The connector includes: a connector shell and the above combined terminal. The combined terminal is inserted into the connector shell.

As shown in FIGS. 19 to 24, in another exemplary embodiment of the present invention, a connector assembly is further disclosed. The connector assembly includes: the above connector and a mating connector. The mating connector mates with the connector. The mating connector includes: a mating shell (not shown) and a mating terminal 3. The mating terminal 3 is disposed in the mating shell. The mating terminal 3 is inserted between the first elastic arm 10 and a contact protrusion 20.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A combined terminal, comprising:
a terminal having a first elastic arm formed at the front of the terminal; and
a shell sleeved on the front of the terminal, wherein:
a contact protrusion or a second elastic arm protruding toward the first elastic arm is formed on a top wall of the shell, and the contact protrusion or the second elastic arm is oppositely spaced from the first elastic arm to clamp a mating terminal inserted between the contact protrusion or the second elastic arm and the first elastic arm, and
a conductive property of a manufacturing material for the terminal is distinct to a conductive property of a manufacturing material for the shell, and a mechanical property of the manufacturing material for the shell is distinct to a mechanical property of the manufacturing material for the terminal.

2. The combined terminal according to claim 1, wherein
the terminal is a copper terminal or a copper alloy terminal, and the shell is a stainless steel shell; or
the terminal is an integral stamped part, and/or the shell is an integral stamped part.

3. The combined terminal according to claim 1, wherein
the front of the terminal comprises a bottom plate, and a bottom wall of the shell abuts against a bottom surface of the bottom plate of the terminal; and
a window is formed in the bottom plate of the terminal, and the first elastic arm of the terminal is suspended in the window.

4. The combined terminal according to claim 3, wherein a front end and a rear end of the first elastic arm are respectively connected to a front side and a rear side of the window in the bottom plate, and the first elastic arm protrudes toward a top wall of the shell for electrical contact with the inserted mating terminal.

5. The combined terminal according to claim 4, wherein the terminal comprises a plurality of first elastic arms arranged side by side in a width direction of the terminal, and the shell comprises a plurality of contact protrusions corresponding to the plurality of first elastic arms respectively or a plurality of second elastic arms corresponding to the plurality of first elastic arms respectively.

6. The combined terminal according to claim 1, wherein
the front of the terminal comprises a bottom plate, and a bottom wall of the shell abuts against a bottom surface of the bottom plate of the terminal; and
the first elastic arm of the terminal comprises:
a first arm portion having a rear end connected to a front side of the bottom plate and a front end supported on the bottom wall of the shell; and
a second arm portion connected to the front end of the first arm portion and bent backward relative to the front end of the first arm portion, the second arm portion being suspended above the first arm portion and protruding toward the top wall of the shell for electrical contact with the inserted mating terminal.

7. The combined terminal according to claim 6, wherein
a tail end of the second arm portion is adapted to be slidably supported on a top surface of the first arm portion when the combined terminal mates with the mating terminal; or
the terminal comprises a plurality of first elastic arms arranged side by side in a width direction of the terminal, and the shell comprises a plurality of contact protrusions corresponding to the plurality of first elastic arms respectively or a plurality of second elastic arms corresponding to the plurality of first elastic arms respectively.

8. The combined terminal according to claim 1, wherein
a second elastic arm is formed on the top wall of the shell, and a front end of the second elastic arm is connected to a front side of the top wall and bent backward relative to the front side of the top wall; and
the second elastic arm is suspended below the top wall and protrudes toward the first elastic arm for electrical contact with the inserted mating terminal.

9. The combined terminal according to claim 8, wherein
a tail end of the second elastic arm is adapted to be slidably supported on an inner surface of the top wall when the combined terminal mates with the mating terminal; or
the shell comprises a plurality of second elastic arms arranged side by side in a width direction of the shell, and the terminal comprises a plurality of first elastic arms corresponding to the plurality of second elastic arms respectively.

10. The combined terminal according to claim 1, wherein the rear of the terminal is located outside the shell, and a crimping portion crimped onto a cable is formed on the rear of the terminal for electrical connection with the cable.

11. The combined terminal according to claim 1, wherein
the shell has two side walls opposite in a width direction of the shell, and riveting tabs are formed on the side walls of the shell;
the front of the terminal has two side plates opposite in a width direction of the terminal, and grooves are formed on upper sides of the side plates of the terminal; and
the riveting tabs on the side walls of the shell are riveted into the grooves in the side plates of the terminal to secure the front of the terminal into the shell.

12. The combined terminal according to claim 1, wherein a tab is formed on one of a bottom plate at the front of the terminal and a bottom wall of the shell, a snap slot is formed in the other, and the tab is locked into the snap slot to lock the front of the terminal into the shell.

13. The combined terminal according to claim 1, wherein the shell further comprises a locking structure located on an outer side of the top wall and/or the bottom wall of the shell, and the locking structure is adapted to engage with a connector shell to lock the combined terminal into the connector shell.

14. The combined terminal according to claim 13, wherein the locking structure comprises a locking tab formed on the outer side of the top wall and/or the bottom wall of the shell, the locking tab being adapted to engage with a locking slot in the connector shell to lock the combined terminal into the connector shell.

15. The combined terminal according to claim 13, wherein the locking structure comprises a top cover located above the top wall of the shell, an opening being formed in a top plate of the top cover, and the opening being adapted to engage with an elastic snap-fit fastener in the connector shell to lock the combined terminal into the connector shell.

16. The combined terminal according to claim 1, wherein
a guide rib is formed on the top wall and/or the bottom wall of the shell, and the guide rib extends in a length direction of the combined terminal; and
the guide rib is configured to mate with a guide slot in the connector shell to guide the insertion of the combined terminal into the connector shell.

17. The combined terminal according to claim 1, wherein a limiting portion turned inward is formed on a front side of the bottom wall of the shell, and the limiting portion is pressed downward on a front end of the first elastic arm of the terminal, such that the first elastic arm is limited in an initial position having a predetermined initial contact force to increase a contact force between the first elastic arm and the mating terminal.

18. The combined terminal according to claim 1, wherein an auxiliary elastic arm is formed on the bottom wall of the shell, and the auxiliary elastic arm protrudes toward the first elastic arm and abuts against a bottom surface of the first elastic arm to increase a contact force between the first elastic arm and the mating terminal.

19. A connector, comprising:
a connector shell; and
a combined terminal of claim 1, the combined terminal being inserted into the connector shell.

20. A connector assembly, comprising:
a connector of claim 19; and
a mating connector mating with the connector,
wherein the mating connector comprises:
a mating shell; and
a mating terminal disposed in the mating shell, and
wherein the mating terminal being inserted between a first elastic arm and a second elastic arm of the combined terminal or between the first elastic arm and a contact protrusion.
